(19) United States
(12) Patent Application Publication
(10) Pub. No.: US 2023/0084369 A1
(43) Pub. Date: Mar. 16, 2023

(54) CONFIGURATION UPDATING METHOD AND APPARATUS, DEVICE AND STORAGE MEDIUM

(71) Applicant: SENSETIME INTERNATIONAL PTE. LTD., Singapore (SG)

(72) Inventors: Jiacheng WU, Singapore (SG); Wenxuan Wu, Singapore (SG); Shuai Zhang, Singapore (SG)

(21) Appl. No.: 17/488,995

(22) Filed: Sep. 29, 2021

Related U.S. Application Data
(63) Continuation of application No. PCT/IB2021/058760, filed on Sep. 26, 2021.

(30) Foreign Application Priority Data
Sep. 14, 2021 (SG) 10202110093V

(51) Int. Cl. H04L 29/08; H04L 29/06; A63F 3/00

(52) U.S. Cl. CPC H04L 67/34; H04L 67/40; H04L 67/16; A63F 3/00895; A63F 2003/00974

(57) ABSTRACT

Provided are a configuration updating method and apparatus, a device, and a storage medium. The method is applied to an edge device and includes that: identification information of a configuration file to be updated in the edge device and first version information of the configuration file are acquired, the configuration file at least including an image, collected by a collection apparatus, of a game region and a parameter of the collection apparatus; second version information of a configuration file in a cloud server is acquired based on the identification information; the configuration file of the second version information is acquired from the cloud server in a case where the second version information is higher than the first version information; and the configuration file in the edge device is updated with the configuration file of the second version information.

### CROSS-REFERENCE TO RELATED APPLICATION(S)

This is continuation of international application PCT/IB2021/058760 filed on 26 Sep. 2021, which claims priority to Singaporean patent application No. 10202110093V filed with IPOS on 14 Sep. 2021. The contents of international application PCT/IB2021/058760 and Singaporean patent application No. 10202110093V are incorporated herein by reference in their entireties.

### TECHNICAL FIELD

Embodiments of the application relate to storage technologies, and relate, but not limited, to a configuration updating method and apparatus, device and storage medium.

### BACKGROUND

In order to meet requirements on the analysis and recognition of tokens on different game tables in some game scenes, an application program needs to be able to read configuration information of different game tables, including tabletop layouts of the game tables, parameters of video cameras arranged for the game tables, etc.

The configuration information usually has the following characteristics: many parameters are included, so files for storing the parameters are large; and different game tables need completely different parameters, so a large number of configuration files are needed and frequently updated.

Consequently, the configuration information (i.e., the configuration files) is updated slowly, and it is likely to make errors by human factors to eventually make it impossible to recognize the tokens on the game tables correctly.

### SUMMARY

In view of this, the embodiments of the application provide a configuration updating method and apparatus, device, and storage medium.

According to a first aspect, an embodiment of the application provides a configuration updating method, which may be applied to an edge device and include the following operations. Identification information of a configuration file to be updated in the edge device and first version information of the configuration file are acquired, the configuration file at least including an image, collected by a collection apparatus, of a game region and a parameter of the collection apparatus. Second version information of a configuration file in a cloud server is acquired based on the identification information. The configuration file of the second version information is acquired from the cloud server in a case where the second version information is higher than the first version information. The configuration file in the edge device is updated with the configuration file of the second version information.

In the abovementioned manner, the version of the configuration file stored in a cloud may be compared with the version of the locally stored configuration file, so that updating time of a related parameter corresponding to the game region is shortened, and human errors that may be generated by manual updating are reduced.

In some embodiments, the method may further include the following operations. A download request is sent to the cloud server in a case of determining that the configuration file does not exist in the edge device, the download request instructing the configuration file in the cloud server to be downloaded. The configuration file sent by the cloud server is received, and the configuration file is stored in the edge device.

In the abovementioned manner, the configuration file of the latest version may be downloaded from the cloud and locally stored for a related program and device to use in a case where the configuration file does not exist locally, so that the failure in the local device caused by a missing parameter is avoided, and the availability of a system is improved.

In some embodiments, the operation that identification information of a configuration file to be updated in the edge device and first version information of the configuration file are acquired may include the following operations. In response to enabling a specific service in the edge device, the identification information of the configuration file to be updated in the edge device and the first version information of the configuration file are acquired. Or, in response to turning on the edge device, the identification information of the configuration file to be updated in the edge device and the first version information of the configuration file are acquired.

In the abovementioned manner, the version of the configuration file stored in the cloud may be compared with the version of the locally stored configuration file when the edge device is turned on or the specific service in the edge device is enabled, so that updating time of a related parameter corresponding to the game region is shortened, and human errors that may be generated by manual updating are reduced.

In some embodiments, the operation that second version information of a configuration file in a cloud server is acquired based on the identification information may include that: the second version information of the configuration file in the cloud server is acquired through a specific interface based on the identification information, the specific interface at least including at least one of the following interfaces: a Representational State Transfer-ful (RESTful) interface or a Google Remote Procedure Call (gRPC) interface. Correspondingly, the method may further include that: the specific service is processed using the configuration file of the first version information in a case where the specific interface is inaccessible.

In the abovementioned manner, the version information of the configuration file in the cloud server may be acquired through the specific interface, and meanwhile, the specific service is processed using the locally stored configuration file when the cloud server is unavailable.

In some embodiments, after the operation that the configuration file in the edge device is updated with the configuration file of the second version information, the method may further include the following operations. The second version information of the configuration file is stored in the configuration file. Or, the second version information of the configuration file is associated with the identification information of the configuration file to obtain association information of the configuration file, and the association information is stored in a version number file.

In the abovementioned manner, all version numbers may be selected to be cached to a separate file in a centralized manner, or may be selected to be cached separately, to implement the storage of the version numbers.

In some embodiments, the method may further include the following operations. A usage time of last usage of each configuration file in the edge device is determined. Configuration files in the edge device are sequenced according to the usage time to obtain a first sequencing result. A configuration file in the edge device is deleted according to the first sequencing result in a case where the number of game regions corresponding to the configuration files in the edge device exceeds a first preset number.

In the abovementioned manner, a local storage space can be saved, and cached configuration files are selectively deleted according to the usage time.

In some embodiments, the method may further include the following operations. A usage count of each configuration file in the edge device is determined. Configuration files in the edge device are sequenced according to the usage counts to obtain a second sequencing result. A configuration file in the edge device is deleted according to the second sequencing result in a case where the number of game regions corresponding to the configuration files in the edge device exceeds a second preset number.

In the abovementioned manner, a local storage space can be saved, and cached configuration files are selectively deleted according to usage counts.

According to a second aspect, an embodiment of the application provides a configuration updating apparatus, which includes a first version acquisition unit, a second version acquisition unit, a file acquisition unit, and an updating unit. The first version acquisition unit is configured to acquire identification information of a configuration file to be updated in an edge device and first version information of the configuration file, the configuration file at least including an image, collected by a collection apparatus, of a game region and a parameter of the collection apparatus. The second version acquisition unit is configured to acquire second version information of a configuration file in a cloud server based on the identification information. The file acquisition unit is configured to acquire the configuration file of the second version information from the cloud server in a case where the second version information is higher than the first version information. The updating unit is configured to update the configuration file in the edge device with the configuration file of the second version information.

According to a third aspect, an embodiment of the application provides an edge device, which may include a memory and a processor. The memory may store a computer program capable of running in the processor. The processor may execute the program to implement the steps in the abovementioned method.

According to a fourth aspect, an embodiment of the application provides a computer-readable storage medium having stored therein a computer program which may be executed by a processor to implement the steps in the abovementioned method.

According to the configuration updating method and apparatus, device and storage medium provided in the embodiments of the application, the identification information of the configuration file to be updated in the edge device and the first version information of the configuration file are acquired, the configuration file at least including the image, collected by the collection apparatus, of the game region and the parameter of the collection apparatus. The second version information of the configuration file in the cloud server is acquired based on the identification information. The configuration file of the second version information is acquired from the cloud server in a case where the second version information is higher than the first version information. The configuration file in the edge device is updated with the configuration file of the second version information. In this manner, the version of the configuration file stored in the cloud may be compared with the version of the locally stored configuration file, so that the updating time of the related parameter corresponding to the game region is shortened, and human errors that may be generated by manual updating are reduced.

### BRIEF DESCRIPTION OF THE DRAWINGS

FIG. 1A is a schematic diagram of system architecture corresponding to a configuration updating method according to an embodiment of the application.

FIG. 1B is a first implementation flowchart of a configuration updating method according to an embodiment of the application.

FIG. 2 is a second implementation flowchart of a configuration updating method according to an embodiment of the application.

FIG. 3 is a third implementation flowchart of a configuration updating method according to an embodiment of the application.

FIG. 4 is a fourth implementation flowchart of a configuration updating method according to an embodiment of the application.

FIG. 5 is a composition structure diagram of a configuration updating apparatus according to an embodiment of the application.

FIG. 6 is a schematic diagram of a hardware entity of an edge device according to an embodiment of the application.

### DETAILED DESCRIPTION

The application will further be elaborated below in combination with the drawings and the embodiments. It is apparent that the described embodiments are not all but only part of embodiments of the application. All other embodiments obtained by those of ordinary skill in the art based on the embodiments of the application without creative work shall fall within the scope of protection of the application.

“Some embodiments” involved in the following descriptions describes a subset of all possible embodiments. However, it can be understood that “some embodiments” may be the same subset or different subsets of all the possible embodiments, and may be combined without conflicts.

In the following descriptions, suffixes for representing components, like “module”, “part” or “unit”, are used only for the ease of describing the application, and they have no specific meanings. Therefore, “module”, “part” or “unit” may be combined for use.

It is to be pointed out that term “first/second/third” involved in the embodiments of the application is only for distinguishing similar objects and does not represent a specific sequence of the objects. It can be understood that “first/second/third” may be interchanged to specific sequences or orders if allowed to implement the embodiments of the application described herein in sequences except the illustrated or described ones.

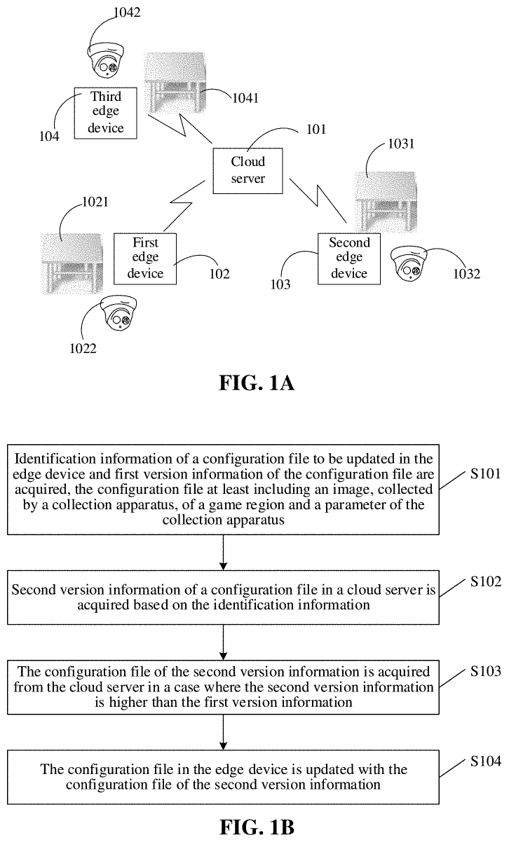

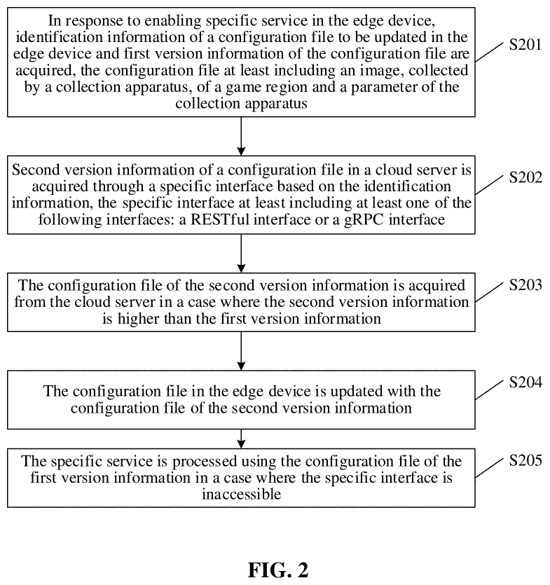

FIG. 1A is a schematic diagram of system architecture corresponding to a configuration updating method according to an embodiment of the application. As shown in FIG. 1A, the system architecture may include a cloud server 101, a first edge device 102, a second edge device 103, and a third edge device 104.

The cloud server 101 may communicate with the first edge device 102, the second edge device 103 and the third edge device 104 respectively. In an implementation process, the cloud server 101 may communicate with any edge device in a wired communication manner and/or a wireless communication manner in a process of the cloud server 101 communicating with any edge device. The first edge device 102 may analyze and recognize tokens and the like on a first game table 1021. The second edge device 103 may analyze and recognize game cards and the like on a second game table 1031. The third edge device 104 may analyze and recognize tokens and the like on a third game table 1041. Furthermore, the first edge device 102 is required to acquire configuration information of the first game table 1021 (including a tabletop layout, collected by a first image collection apparatus 1022, of the first game table 1021 and a parameter of the first image collection apparatus 1022). The second edge device 103 is required to acquire configuration information of the second game table 1031 (including a tabletop layout, collected by a second image collection apparatus 1032, of the second game table 1031 and a parameter of the second image collection apparatus 1032). The third edge device 104 is required to acquire configuration information of the third game table 1041 (including a tabletop layout, collected by a third image collection apparatus 1042, of the third game table 1041 and a parameter of the third image collection apparatus 1042). Moreover, the image collection apparatus may be a video camera, a camera, etc. A game table corresponds to at least one image collection apparatus. For example, different game tables correspond to multiple cameras responsible for shooting tabletop layout images of the game tables in different directions.

The embodiment of the application is not limited thereto. The cloud server may communicate with another number of edge devices. The other number is, for example, 1, 2, or an integer more than or equal to 3. For example, the other number may be the number of all game tables in one entertainment place or multiple entertainment places. A game table in all the game tables may correspond to one edge device. In an embodiment, multiple game tables may correspond to one edge device. No limits are made thereto in the embodiment of the application.

In some implementation modes, any edge device may directly communicate with the cloud server. In some other implementation modes, any edge device may communicate with the cloud server through a server in an entertainment place, so that the server in the entertainment place may monitor communication data between the cloud server and any edge device.

Based on this, an embodiment of the application provides a configuration updating method, which is applied to an edge device. A function realized by the method may be realized by a processor in the edge device by calling a program code. Of course, the program code may be stored in a storage medium of the edge device. FIG. 1B is a first implementation flowchart of a configuration updating method according to an embodiment of the application. As shown in FIG. 1B, the method includes the following operations.

In S101, identification information of a configuration file to be updated in the edge device and first version information of the configuration file are acquired, the configuration file at least including an image, collected by a collection apparatus, of a game region and a parameter of the collection apparatus.

Here, the edge device may be various types of devices with an information processing capability, e.g., a mobile phone, a Personal Digital Assistant (PDA), a tablet computer, a navigator, and an all-in-one machine. The edge device may be a bridge device that connects the cloud server with a video camera corresponding to a game table, and may perform Artificial Intelligence (AI) processing on a picture shot by the video camera and upload to a cloud.

In the embodiment of the application, the same configuration file has unique identification information and different version information. For example, a configuration file A includes an image, shot by a video camera A in a certain direction, of a game region A and a parameter of the video camera A. In such case, the configuration file A has unique identification information. The configuration file A has first version information at a first moment. At a second moment, tokens and game cards in the game region A or a layout of the game region A changes, or the parameter of the video camera A changes, so the configuration file A has second version information at the second moment. The version information may be represented by a version number, or may be represented by timestamp information of the configuration file. No limits are made thereto in the embodiment of the application.

Of course, the game region may be a certain region on the game table, or may be the whole region on the game table. Multiple cameras may be arranged on different game tables in different directions to shoot tabletop layout images of the game tables. In such case, the tabletop layout images, shot by each camera, of the game tables and camera parameters are different. The layout images and camera parameters of the same game table may be stored in one or more configuration files in any manner.

In some embodiments, the first version information of the configuration file may be acquired from the configuration file to be updated (namely the first version information may be stored in the configuration file). In an embodiment, the first version information of the configuration file may be acquired from a specific version number file, namely the identification information and corresponding first version information of the configuration file are stored in the specific version number file as a key value.

In S102, second version information of a configuration file in a cloud server is acquired based on the identification information.

Here, the acquired configuration file in the edge device and the acquired configuration file in the cloud server have the same identification information, and version information thereof may be the same or different.

In S103, the configuration file of the second version information is acquired from the cloud server in a case where the second version information is higher than the first version information.

Here, if the version of the configuration file in the cloud server is higher than the version of the configuration file in the edge device, namely the version of the configuration file in the cloud server is newer, the configuration file in the cloud server is downloaded to update the local configuration file. In this manner, the version of the configuration file stored in the cloud may be compared with the version of the locally stored configuration file, so that updating time of a related parameter corresponding to the game region is shortened, and human errors that may be generated by manual updating are reduced.

In S104, the configuration file in the edge device is updated with the configuration file of the second version information.

In some embodiments, after the operation in S104 that the configuration file in the edge device is updated with the configuration file of the second version information, the method further includes that: the second version information of the configuration file is stored in the configuration file.

Here, the version information of the updated configuration file may be directly stored in the configuration file after the configuration file in the edge device is updated with the configuration file stored in the cloud server.

In some embodiments, after the operation in S104 that the configuration file in the edge device is updated with the configuration file of the second version information, the method further includes the following operations.

In S11, the second version information of the configuration file is associated with the identification information of the configuration file to obtain association information of the configuration file.

In S12, the association information is stored in a version number file.

Here, after the configuration file in the edge device is updated with the configuration file stored in the cloud server, version information of multiple updated configuration files may be associated with identification information of corresponding configuration files to obtain multiple pieces of association information, and then the multiple pieces of association information are stored in a special version number file.

Based on the abovementioned embodiment, an embodiment of the application also provides a configuration updating method, which is applied to an edge device and includes the following operations.

In S111, identification information of a configuration file to be updated in the edge device and first version information of the configuration file are acquired, the configuration file at least including an image, collected by a collection apparatus, of a game region and a parameter of the collection apparatus.

In S112, second version information of a configuration file in a cloud server is acquired based on the identification information.

In S113, the configuration file of the second version information is acquired from the cloud server in a case where the second version information is higher than the first version information.

In S114, the configuration file in the edge device is updated with the configuration file of the second version information.

In S115, a download request is sent to the cloud server in a case of determining that the configuration file does not exist in the edge device, the download request instructing the configuration file in the cloud server to be downloaded.

Here, if the configuration file does not exist in the edge device, comparison cannot be implemented, and the configuration file in the cloud server is directly downloaded and locally stored for a related program and device to use. Therefore, the failure in the local device cause by a missing parameter is avoided, and the availability of a system is improved.

In S116, the configuration file sent by the cloud server is received, and the configuration file is stored in the edge device.

In some embodiments, the operation in S111 that identification information of a configuration file to be updated in the edge device and first version information of the configuration file are acquired includes that: in response to enabling specific service in the edge device, the identification information of the configuration file to be updated in the edge device and the first version information of the configuration file are acquired.

In some embodiments, the operation in S111 that identification information of a configuration file to be updated in the edge device and first version information of the configuration file are acquired includes that: in response to turning on the edge device, the identification information of the configuration file to be updated in the edge device and the first version information of the configuration file are acquired.

Based on the abovementioned embodiments, an embodiment of the application also provides a configuration updating method, which is applied to an edge device and includes the following operations.

In S121, in response to enabling specific service in the edge device, identification information of a configuration file to be updated in the edge device and first version information of the configuration file are acquired, the configuration file at least including an image, collected by a collection apparatus, of a game region and a parameter of the collection apparatus.

Here, the version of the configuration file stored in a cloud may be compared with the version of the locally stored configuration file when the specific service in the edge device is enabled or the edge device is turned on, so that updating time of a related parameter corresponding to the game region is shortened, and human errors that may be generated by manual updating are reduced.

In S122, second version information of a configuration file in a cloud server is acquired based on the identification information.

In S123, the configuration file of the second version information is acquired from the cloud server in a case where the second version information is higher than the first version information.

In S124, the configuration file in the edge device is updated with the configuration file of the second version information.

In S125, the specific service is processed using the configuration file in the edge device.

Here, the specific service may be processed using the updated configuration file after the local configuration file is updated with the configuration file in the cloud server.

Based on the abovementioned embodiments, an embodiment of the application also provides a configuration updating method, which is applied to an edge device. FIG. 2 is a second implementation flowchart of a configuration updating method according to an embodiment of the application. As shown in FIG. 2, the method includes the following operations.

In S201, in response to enabling specific service in the edge device, identification information of a configuration file to be updated in the edge device and first version information of the configuration file are acquired, the configuration file at least including an image, collected by a collection apparatus, of a game region and a parameter of the collection apparatus.

In S202, second version information of a configuration file in a cloud server is acquired through a specific interface based on the identification information, the specific interface at least including at least one of the following interfaces: a RESTful interface or a gRPC interface.

Here, RESTful is a design style and development manner of a network application program based on Hyper Text Transfer Protocol (HTTP), and may be defined in an Extensible Markup Language (XML) format or a JavaScript Object Notation (JSON) format. RESTful is applicable to a scene that a mobile Internet manufacturer serves as a service interface, and realizes a function of calling a mobile network resource by a third party, and operation types include addition, modification and deletion of the called resource. gRPC is a language-neutral, platform-neutral and open-source Remote Procedure Call (RPC) system. In gRPC, a client application may directly call a server application in another different machine like calling a local object, so that distributed applications and service may be created more easily. Therefore, the version information of the configuration file in the cloud may be acquired through the specific interface in the embodiment of the application.

In S203, the configuration file of the second version information is acquired from the cloud server in a case where the second version information is higher than the first version information.

In S204, the configuration file in the edge device is updated with the configuration file of the second version information.

In S205, the specific service is processed using the configuration file of the first version information in a case where the specific interface is inaccessible.

Here, the specific service is processed using the locally stored configuration file in a case where the cloud server is unavailable.

Based on the abovementioned embodiments, an embodiment of the application also provides a configuration updating method, which is applied to an edge device and includes the following operations.

In S211, in response to enabling specific service in the edge device, identification information of a configuration file to be updated in the edge device and first version information of the configuration file are acquired, the configuration file at least including an image, collected by a collection apparatus, of a game region and a parameter of the collection apparatus.

In S212, second version information of a configuration file in a cloud server is acquired through a specific interface based on the identification information, the specific interface at least including at least one of the following interfaces: a RESTful interface or a gRPC interface.

In S213, the configuration file of the second version information is acquired from the cloud server in a case where the second version information is higher than the first version information.

In S214, the configuration file in the edge device is updated with the configuration file of the second version information.

In S215, the second version information of the configuration file is stored in the configuration file.

Here, the storage of version numbers may be implemented by selecting to execute S215 or selecting to execute S216 to S217. A separate caching manner is implemented by S215. A manner of caching the version numbers to a separate file in a centralized manner is implemented by S216 to S217.

In S216, the second version information of the configuration file is associated with the identification information of the configuration file to obtain association information of the configuration file.

In S217, the association information is stored in a version number file.

In S218, the specific service is processed using the configuration file of the first version information in a case where the specific interface is inaccessible.

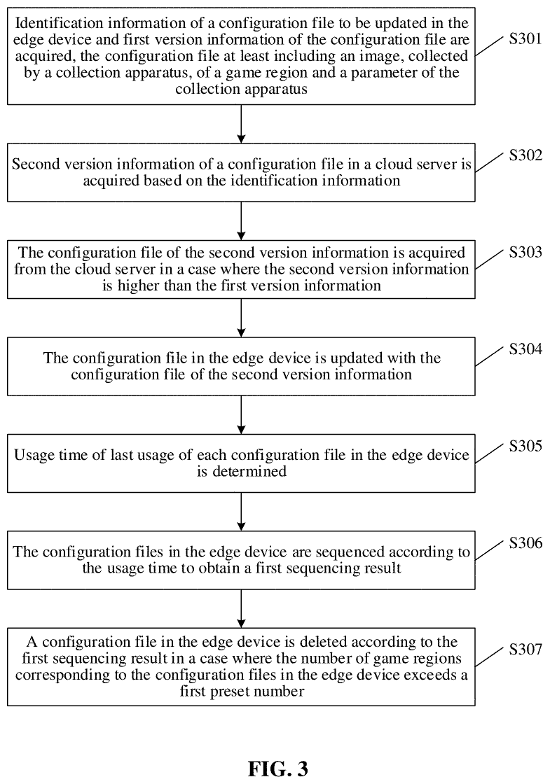

Based on the abovementioned embodiments, an embodiment of the application also provides a configuration updating method, which is applied to an edge device. FIG. 3 is a third implementation flowchart of a configuration updating method according to an embodiment of the application. As shown in FIG. 3, the method includes the following operations.

In S301, identification information of a configuration file to be updated in the edge device and first version information of the configuration file are acquired, the configuration file at least including an image, collected by a collection apparatus, of a game region and a parameter of the collection apparatus.

In S302, second version information of a configuration file in a cloud server is acquired based on the identification information.

In S303, the configuration file of the second version information is acquired from the cloud server in a case where the second version information is higher than the first version information.

In S304, the configuration file in the edge device is updated with the configuration file of the second version information.

In S305, usage time of last usage of each configuration file in the edge device is determined.

Here, it may be set that the usage time of the last usage of the configuration file is stored in the configuration file. In an embodiment, the usage time of the last usage of the configuration file is associated with the identification information of the configuration file, and association information is stored in a specific file.

In S306, the configuration files in the edge device are sequenced according to the usage time to obtain a first sequencing result.

Here, the configuration files in the edge device may be sequenced according to the usage time from early to late (for example, the usage time is 2010, 2012, 2015, and 2021), and then a configuration file that is not used for long is deleted according to the sequencing result, so that a local storage space is saved.

In S307, a configuration file in the edge device is deleted according to the first sequencing result in a case where the number of game regions corresponding to the configuration files in the edge device exceeds a first preset number.

Based on the abovementioned embodiments, an embodiment of the application also provides a configuration updating method, which is applied to an edge device and includes the following operations.

In S311, identification information of a configuration file to be updated in the edge device and first version information of the configuration file are acquired, the configuration file at least including an image, collected by a collection apparatus, of a game region and a parameter of the collection apparatus.

In S312, second version information of a configuration file in a cloud server is acquired based on the identification information.

In S313, the configuration file of the second version information is acquired from the cloud server in a case where the second version information is higher than the first version information.

In S314, the configuration file in the edge device is updated with the configuration file of the second version information.

In S315, a usage count of each configuration file in the edge device is determined.

In S316, the configuration files in the edge device are sequenced according to the usage counts to obtain a second sequencing result.

Here, the configuration files in the edge device may be sequenced according to usage counts from small to large (for example, the usage counts are 20, 30, 50, and 100), and then a configuration file corresponding to a small usage count is deleted according to the sequencing result, so that a local storage space is saved.

In S317, a configuration file in the edge device is deleted according to the second sequencing result in a case where the number of game regions corresponding to the configuration files in the edge device exceeds a second preset number.

At present, in order to meet requirements on the recognition and analysis of elements such as tokens and game cards on different game tables in an entertainment game and other scenes, an application program needs to be able to read configuration information of different game tables, including tabletop layouts of the game tables, parameters of video cameras arranged for the game tables, etc. A configuration file corresponding to such configuration information has the following characteristics.

1) Many parameters are included, so files for storing the parameters are large. 2) Different game tables need completely different parameters, so a large number of configuration files are needed. 3) The parameters are frequently updated.

Due to the above characteristics of the related parameters, the parameters are updated slowly, and it is likely to make errors by human factors to eventually make it impossible to recognize the tokens, game cards and the like on the game tables correctly.

Based on this, an embodiment of the application discloses a configuration updating method, mainly local caching strategies for different game tables and parameters of video cameras arranged for them in a game scene under normal and failure conditions. A configuration file is cached to shorten updating time of the configuration file and reduce an error rate of manual updating.

At first, a version number may be set for each of different versions of the same configuration file. An edge device compares a configuration file that has existed or does not exist locally to judge whether the file is required to be updated. The edge device loads local caches in case of a failure.

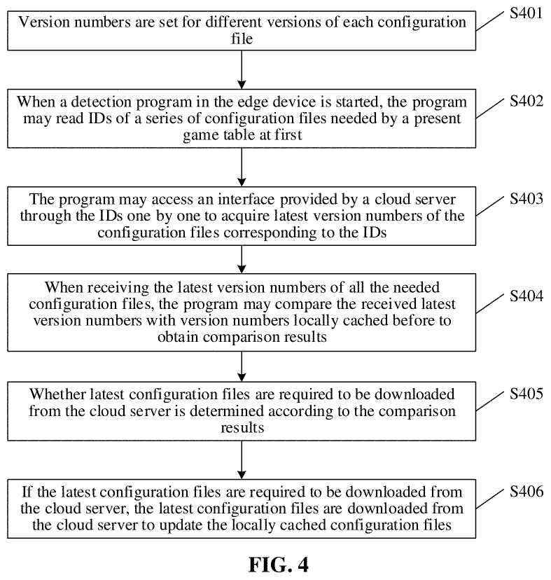

FIG. 4 is a fourth implementation flowchart of a configuration updating method according to an embodiment of the application. As shown in FIG. 4, the configuration updating method provided in the embodiment of the application may be implemented through the following operations under a normal condition.

In S401, version numbers are set for different versions of each configuration file.

Here, each configuration file may include at least one parameter. The same configuration file may have a unique Identity document (ID). The configuration file of each version may have a version number corresponding to its version, and a version number corresponding to an updated version may be larger. For example, if a present version number is 1, an updated version number of the configuration file is 2. Of course, different versions of the same configuration file may also be distinguished by timestamps of the configuration file.

In the embodiment of the application, different versions of all configuration files may be managed in a cloud in a unified manner, and are downloaded by the edge device through HTTP. In addition, a cloud server may also provide a RESTful interface for the edge device to check a latest version of the configuration file.

In S402, when a detection program in the edge device is started, the program may read IDs of a series of configuration files needed by a present game table at first.

In S403, the program may access an interface provided by a cloud server through the IDs one by one to acquire latest version numbers of the configuration files corresponding to the IDs.

Here, the interface may be a RESTful interface or a gRPC interface. The interface may return the latest version numbers of the configuration files corresponding to the IDs.

In S404, when receiving the latest version numbers of all the needed configuration files, the program may compare the received latest version numbers with version numbers locally cached before to obtain comparison results.

Here, the version numbers locally cached before may be stored in a file versions.json in a centralized manner. If the program may find the version numbers, cached before, of the configuration files, the cached version numbers and latest version numbers of each configuration files needed by the program may be compared one by one.

In S405, whether latest configuration files are required to be downloaded from the cloud server is determined according to the comparison results.

Here, the version numbers of the configuration files are compared based on the latest ones. For example, if a cached version number of a configuration file AAA is 2 while a latest version number returned by the interface is 3, a comparison result is 3. After obtaining the comparison result of the version numbers, the program may access the interface in S403 to try to download a latest configuration file.

In S406, if the latest configuration files are required to be downloaded from the cloud server, the latest configuration files are downloaded from the cloud server to update the locally cached configuration files.

The above is a configuration updating strategy under a normal condition. In case of a failure, the configuration updating method may be implemented in the following manner.

1) If the interface providing the latest version numbers in S403 is inaccessible, the program may skip all the above operations and use existing local caches for normal execution. If there are no locally cached files, the program cannot execute.

2) If the program cannot find any version number that is locally cached before in S404, new cache versions.json may be created using the received latest version numbers of the configuration files, and the new version numbers are used as the comparison results in S404.

3) If the latest configuration files fail to be downloaded in S406, the version numbers in versions.json may not change.

Of course, there may be some implementation modes as follows.

1) For the same configuration file, whether a version number thereof is new or old is not always judged based on a magnitude. Any manner capable of clearly indicating whether the version number is new or old, e.g., a numeral, a symbol and a letter, may be used as the version number. For example, timestamp information of the configuration file may be used as the version number.

2) Besides RESTful, the interface providing the latest version numbers of the configuration files may also use an interface corresponding to an RPC protocol such as gRPC. Besides HTTP, the interface for downloading the latest configuration files may also use File Transfer Protocol (FTP) and other protocols.

3) The version number of each configuration file may be stored in the configuration file, or version numbers of multiple configuration files may be stored in a separate version number file. Moreover, the locally cached version number file may be a file of any file name and any format, e.g., yaml and xml.

4) In order to save the space, the locally cached configuration file may be selectively deleted. The following deletion standards may be adopted.

A first standard: configuration files corresponding only N different types of game tables are cached. If more than N types of game tables are cached, a configuration file corresponding to earliest usage time of last usage of may be deleted, N being a natural number more than or equal to 2.

A second standard: configuration files corresponding to only M different types of game tables are cached. If more than M types of game tables are cached, a configuration file corresponding to a smallest historical usage count may be deleted, M being a natural number more than or equal to 2.

Of course, as described above, information such as usage time or a usage count is required to be used, the information may also be written in versions.json or a similar cache file.

According to the configuration updating method provided in the embodiment of the application, updating time of a related parameter such as a game table and a video camera thereof may be shortened, and human errors that may be generated by manually updating the related parameter such as the game table and the video camera thereof are reduced. Meanwhile, according to the configuration updating method in the embodiment of the application, the failure at a game table caused by a missing parameter is avoided, and the availability of a system is improved. A local caching strategy described in the method is used to manage the parameter needed by the game table to shorten the parameter updating time and reduce errors that may be generated in a manual updating process.

Based on the abovementioned embodiments, an embodiment of the application provides a configuration updating apparatus. Each unit of the apparatus, each module of each unit and each component of each module may be implemented by a processor in a biometric feature recognition device and, of course, may also be implemented by a specific logic circuit. In an implementation process, the processor may be a Central Processing Unit (CPU), a Microprocessor Unit (MPU), a Digital Signal Processor (DSP), a Field Programmable Gate Array (FPGA), or the like.

FIG. 5 is a composition structure diagram of a configuration updating apparatus according to an embodiment of the application. As shown in FIG. 5, the apparatus 500 includes a first version acquisition unit 501, a second version acquisition unit 502, a file acquisition unit 503, and an updating unit 504.

The first version acquisition unit 501 is configured to acquire identification information of a configuration file to be updated in an edge device and first version information of the configuration file, the configuration file at least including an image, collected by a collection apparatus, of a game region and a parameter of the collection apparatus.

The second version acquisition unit 502 is configured to acquire second version information of a configuration file in a cloud server based on the identification information.

The file acquisition unit is configured to acquire the configuration file of the second version information from the cloud server in a case where the second version information is higher than the first version information.

The updating unit 504 is configured to update the configuration file in the edge device with the configuration file of the second version information.

In some embodiments, the apparatus further includes a downloading unit and a storage unit.

The downloading unit is configured to send a download request to the cloud server in a case of determining that the configuration file does not exist in the edge device, the download request instructing the configuration file in the cloud server to be downloaded.

The storage unit is configured to receive the configuration file sent by the cloud server and store the configuration file in the edge device.

In some embodiments, the first version acquisition unit includes a first version acquisition subunit.

The first version acquisition subunit is configured to, in response to enabling specific service in the edge device, acquire the identification information of the configuration file to be updated in the edge device and the first version information of the configuration file.

In an embodiment, the first version acquisition subunit is further configured to, in response to turning on the edge device, acquire the identification information of the configuration file to be updated in the edge device and the first version information of the configuration file.

In some embodiments, the second version acquisition unit 502 includes a second version acquisition subunit.

The second version acquisition subunit is configured to acquire second version information of a configuration file in a cloud server through a specific interface based on the identification information, the specific interface at least including at least one of the following interfaces: a RESTful interface or a gRPC interface.

Correspondingly, the apparatus further includes a processing unit.

The processing unit is configured to process the specific service using the configuration file of the first version information in a case where the specific interface is inaccessible.

In some embodiments, the apparatus further includes: a first version storage unit; or an association unit and a second version storage unit.

The first version storage unit is configured to store the second version information of the configuration file in the configuration file.

The association unit is configured to associate the second version information of the configuration file and the identification information of the configuration file to obtain association information of the configuration file.

The second version storage unit is configured to store the association information in a version number file.

In some embodiments, the apparatus further includes a time determination unit, a first sequencing unit, and a first deletion unit.

The time determination unit is configured to determine usage time of last usage of each configuration file in the edge device.

The first sequencing unit is configured to sequence the configuration files in the edge device according to the usage time to obtain a first sequencing result.

The first deletion unit is configured to delete a configuration file in the edge device according to the first sequencing result in a case where the number of game regions corresponding to the configuration files in the edge device exceeds a first preset number.

In some embodiments, the apparatus further includes a count determination unit, a second sequencing unit, and a second deletion unit.

The count determination unit is configured to determine a usage count of each configuration file in the edge device.

The second sequencing unit is configured to sequence the configuration files in the edge device according to the usage counts to obtain a second sequencing result.

The second deletion unit is configured to delete a configuration file in the edge device according to the second sequencing result in a case where the number of game regions corresponding to the configuration files in the edge device exceeds a second preset number.

The above descriptions about the apparatus embodiments are similar to those about the method embodiments and beneficial effects similar to those of the method embodiments are achieved. Technical details undisclosed in the apparatus embodiment of the application may be understood with reference to the descriptions about the method embodiment of the application.

It is to be noted that, in the embodiments of the application, the configuration updating method may also be stored in a computer-readable storage medium when being implemented in form of a software function module and sold or used as an independent product. Based on such an understanding, the embodiments of the application substantially or parts making contributions to the conventional art may be embodied in form of a software product. The computer software product is stored in a storage medium, including a plurality of instructions configured to enable an electronic device (which may be a personal computer, a server, etc.) to execute all or part of the method in each embodiment of the application. The storage medium includes various media capable of storing program codes such as a U disk, a mobile hard disk, a Read Only Memory (ROM), a magnetic disk, or an optical disk. Therefore, the embodiments of the application are not limited to any specific hardware and software combination.

Correspondingly, an embodiment of the application provides a biometric feature recognition device, which includes a memory and a processor. The memory stores a computer program capable of running in the processor. The processor executes the program to implement the steps in the configuration updating method provided in the abovementioned embodiment.

Correspondingly, an embodiment of the application provides a readable storage medium having stored therein a computer program which is executed by a processor to implement the steps in the configuration updating method.

It is to be pointed out here that the above descriptions about the storage medium and device embodiments are similar to those about the method embodiment, and beneficial effects similar to those of the method embodiment are achieved. Technical details undisclosed in the storage medium and device embodiments of the application are understood with reference to the descriptions about the method embodiment of the application.

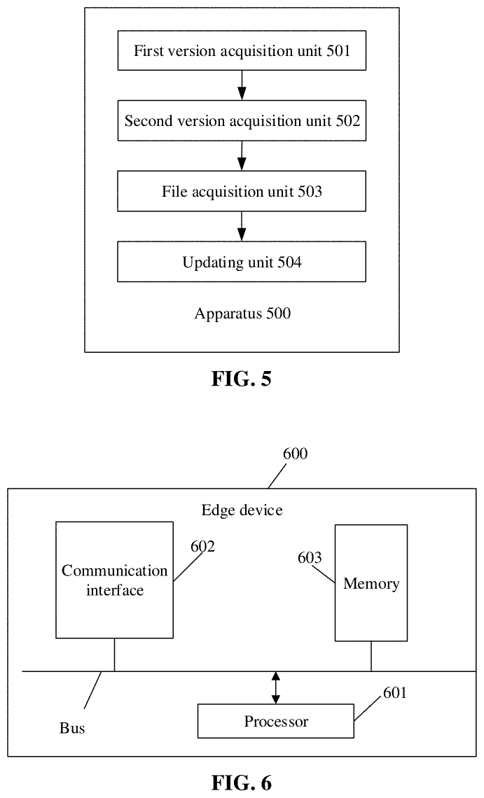

It is to be noted that FIG. 6 is a schematic diagram of a hardware entity of an edge device according to an embodiment of the application. As shown in FIG. 6, the hardware entity of the edge device 600 includes a processor 601, a communication interface 602, and a memory 603.

The processor 601 usually controls overall operations of the edge device 600.

The communication interface 602 may enable the edge device 600 to communicate with another electronic device or a server through a network.

The memory 603 is configured to store an instruction and application executable for the processor 601, may also cache data (for example, image data, video data, voice communication data, and video communication data) to be processed or having been processed by the processor 601 and each module in the edge device 600, and may be implemented by a flash or a Random Access Memory (RAM).

In some embodiments provided by the application, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement.

In addition, each function unit in each embodiment of the application may be integrated into a processing module, each unit may also serve as an independent unit and two or more than two units may also be integrated into a unit. The integrated unit may be implemented in a hardware form and may also be implemented in form of hardware and software function unit. Those of ordinary skill in the art should know that all or part of the steps of the method embodiment may be implemented by related hardware instructed through a program, the program may be stored in a computer-readable storage medium, and the program is executed to execute the steps of the method embodiment. The storage medium includes: various media capable of storing program codes such as a mobile storage device, a ROM, a RAM, a magnetic disk or a compact disc.

The methods disclosed in some method embodiments provided in the application may be freely combined without conflicts to obtain new method embodiments.

The characteristics disclosed in some product embodiments provided in the application may be freely combined without conflicts to obtain new product embodiments.

The characteristics disclosed in some method or device embodiments provided in the application may be freely combined without conflicts to obtain new method embodiments or device embodiments.

The above is only the specific implementation mode of the application and not intended to limit the scope of protection of the application. Any variations or replacements apparent to those skilled in the art within the technical scope disclosed by the application shall fall within the scope of protection of the application. Therefore, the scope of protection of the application shall be subject to the scope of protection of the claims.

What is claimed is:

1. A configuration updating method, applied to an edge device and comprising:
acquiring identification information of a configuration file to be updated in the edge device and first version information of the configuration file, the configuration file at least comprising an image, collected by a collection apparatus, of a game region and a parameter of the collection apparatus;
acquiring second version information of a configuration file in a cloud server based on the identification information;
acquiring the configuration file of the second version information from the cloud server in a case where the second version information is higher than the first version information; and
updating the configuration file in the edge device with the configuration file of the second version information.

2. The method of claim 1, further comprising:
sending a download request to the cloud server in a case of determining that the configuration file does not exist in the edge device, the download request instructing the configuration file in the cloud server to be downloaded; and
receiving the configuration file sent by the cloud server, and storing the configuration file in the edge device.

3. The method of claim 1, wherein the acquiring identification information of a configuration file to be updated in the edge device and first version information of the configuration file comprises:
in response to enabling a specific service in the edge device, acquiring the identification information of the configuration file to be updated in the edge device and the first version information of the configuration file; or
in response to turning on the edge device, acquiring the identification information of the configuration file to be updated in the edge device and the first version information of the configuration file.

4. The method of claim 3, wherein the acquiring second version information of a configuration file in a cloud server based on the identification information comprises:
acquiring the second version information of the configuration file in the cloud server through a specific interface based on the identification information, the specific interface at least comprising at least one of the following interfaces: a Representational State Transfer-ful (RESTful) interface or a Google Remote Procedure Call (gRPC) interface;
correspondingly, the method further comprises:
processing the specific service using the configuration file of the first version information in a case where the specific interface is inaccessible.

5. The method of claim 1, after the updating the configuration file in the edge device with the configuration file of the second version information, further comprising:
storing the second version information of the configuration file in the configuration file;
or,
associating the second version information of the configuration file and the identification information of the configuration file to obtain association information of the configuration file, and
storing the association information in a version number file.

6. The method of claim 1, further comprising:
determining a usage time of last usage of each configuration file in the edge device;
sequencing a plurality of configuration files in the edge device according to the usage time to obtain a first sequencing result; and
deleting a configuration file in the edge device according to the first sequencing result in a case where a number of game regions corresponding to the configuration files in the edge device exceeds a first preset number.

7. The method of claim 1, further comprising:
determining a usage count of each configuration file in the edge device;
sequencing a plurality of configuration files in the edge device according to the usage count to obtain a second sequencing result; and
deleting a configuration file in the edge device according to the second sequencing result in a case where a number of game regions corresponding to the configuration files in the edge device exceeds a second preset number.

8. An edge device, comprising a memory and a processor, wherein the memory stores a computer program capable of running in the processor, and when executing the computer program, the processor is configured to:
acquire identification information of a configuration file to be updated in the edge device and first version information of the configuration file, the configuration file at least comprising an image, collected by a collection apparatus, of a game region and a parameter of the collection apparatus;
acquire second version information of a configuration file in a cloud server based on the identification information;
acquire the configuration file of the second version information from the cloud server in a case where the second version information is higher than the first version information; and
update the configuration file in the edge device with the configuration file of the second version information.

9. The edge device of claim 8, wherein the processor is further configured to:
send a download request to the cloud server in a case of determining that the configuration file does not exist in the edge device, the download request instructing the configuration file in the cloud server to be downloaded; and
receive the configuration file sent by the cloud server, and storing the configuration file in the edge device.

10. The edge device of claim 8, wherein when acquiring the identification information of the configuration file to be updated in the edge device and the first version information of the configuration file, the processor is configured to:
in response to enabling a specific service in the edge device, acquire the identification information of the configuration file to be updated in the edge device and the first version information of the configuration file; or
in response to turning on the edge device, acquire the identification information of the configuration file to be updated in the edge device and the first version information of the configuration file.

11. The edge device of claim 10, wherein when acquiring the second version information of the configuration file in the cloud server based on the identification information, the processor is configured to:
acquire the second version information of the configuration file in the cloud server through a specific interface based on the identification information, the specific interface at least comprising at least one of the following interfaces: a Representational State Transfer-ful (RESTful) interface or a Google Remote Procedure Call (gRPC) interface;
correspondingly, the processor is further configured to:
process the specific service using the configuration file of the first version information in a case where the specific interface is inaccessible.

12. The edge device of claim 8, wherein after updating the configuration file in the edge device with the configuration file of the second version information, the processor is further configured to:
store the second version information of the configuration file in the configuration file; or,
associate the second version information of the configuration file and the identification information of the configuration file to obtain association information of the configuration file, and
store the association information in a version number file.

13. The edge device of claim 8, wherein the processor is further configured to:
determine a usage time of last usage of each configuration file in the edge device;
sequence a plurality of configuration files in the edge device according to the usage time to obtain a first sequencing result; and
delete a configuration file in the edge device according to the first sequencing result in a case where a number of game regions corresponding to the configuration files in the edge device exceeds a first preset number.

14. The edge device of claim 8, wherein the processor is further configured to:
determine a usage count of each configuration file in the edge device;
sequence a plurality of configuration files in the edge device according to the usage count to obtain a second sequencing result; and
delete a configuration file in the edge device according to the second sequencing result in a case where a number of game regions corresponding to the configuration files in the edge device exceeds a second preset number.

15. A nonvolatile computer-readable storage medium having stored therein a computer program, wherein when executed by a processor, the computer program is configured to:
acquire identification information of a configuration file to be updated in an edge device and first version information of the configuration file, the configuration file at least comprising an image, collected by a collection apparatus, of a game region and a parameter of the collection apparatus;
acquire second version information of a configuration file in a cloud server based on the identification information;
acquire the configuration file of the second version information from the cloud server in a case where the second version information is higher than the first version information; and
update the configuration file in the edge device with the configuration file of the second version information.

16. The nonvolatile computer-readable storage medium of claim 15, wherein the computer program is further configured to:
send a download request to the cloud server in a case of determining that the configuration file does not exist in the edge device, the download request instructing the configuration file in the cloud server to be downloaded; and
receive the configuration file sent by the cloud server, and storing the configuration file in the edge device.

17. The nonvolatile computer-readable storage medium of claim 15, wherein when acquiring the identification information of the configuration file to be updated in the edge device and the first version information of the configuration file, the computer program is configured to:
in response to enabling a specific service in the edge device, acquire the identification information of the configuration file to be updated in the edge device and the first version information of the configuration file; or
in response to turning on the edge device, acquire the identification information of the configuration file to be updated in the edge device and the first version information of the configuration file.

18. The nonvolatile computer-readable storage medium of claim 17, wherein when acquiring the second version information of the configuration file in the cloud server based on the identification information, the computer program is configured to:
acquire the second version information of the configuration file in the cloud server through a specific interface based on the identification information, the specific interface at least comprising at least one of the following interfaces: a Representational State Transfer-ful (RESTful) interface or a Google Remote Procedure Call (gRPC) interface;
correspondingly, the processor is further configured to:
process the specific service using the configuration file of the first version information in a case where the specific interface is inaccessible.

19. The nonvolatile computer-readable storage medium of claim 15, wherein after updating the configuration file in the edge device with the configuration file of the second version information, the computer program is further configured to:
store the second version information of the configuration file in the configuration file; or,
associate the second version information of the configuration file and the identification information of the configuration file to obtain association information of the configuration file, and
store the association information in a version number file.

20. The nonvolatile computer-readable storage medium of claim 15, wherein the computer program is further configured to:
determine a usage time of last usage of each configuration file in the edge device;
sequence a plurality of configuration files in the edge device according to the usage time to obtain a first sequencing result; and
delete a configuration file in the edge device according to the first sequencing result in a case where a number of game regions corresponding to the configuration files in the edge device exceeds a first preset number.
